(19) United States
(12) Patent Application Publication
(10) Pub. No.: US 2006/0068232 A1
(43) Pub. Date: Mar. 30, 2006

(54) Magnetic tape

(75) Inventors: Hisanobu Mikamo, Osaka (JP); Seigi Kawarai, Osaka (JP); Sadamu Kuse, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD., Osaka (JP)

(21) Appl. No.: 10/948,259

(22) Filed: Sep. 24, 2004

(51) Int. Cl. G11B 5/708

(52) U.S. Cl. 428/842.9; 428/842

(57) ABSTRACT

A magnetic tape comprising a non-magnetic substrate and at least one magnetic layer formed on one surface of the non-magnetic substrate, characterized in that magnetic particles contained in an uppermost magnetic layer of the magnetic layer are substantially granular particles with a particle size of 30 nm or less, and that the ratio of a coercive force Hc_{M} in the machine direction to a coercive force Hc_{T} in the transverse direction, i.e., [Hc_{M}/Hc_{T}], is at least 2.2. This magnetic tape has a capacity capable of corresponding to mass storage of 1 TB or more, and achieves a high ratio of reproducing output to noises (C/N), particularly for signals within a short wavelength range, thus showing excellent high-density recording performance.

### FIELD OF THE INVENTION

The present invention relates to a magnetic tape excellent in high density recording performance, and in particular, to a coating type magnetic recording tape.

### BACKGROUND OF THE INVENTION

Magnetic recording tapes (hereinafter simply referred to as “magnetic tapes” or “tapes”) have found a variety of applications in audio tapes, video tapes, computer tapes, etc. Above all, in the field of data backup tapes, magnetic tapes each having a recording capacity of several tens to one hundred GB per reel have been commercialized, in association with the increased mass storage of hard discs for backup. Further, there is proposed a mass storage backup tape having a capacity exceeding 1 TB. Under these circumstances, it is indispensable to provide magnetic tapes having far higher density recording performance.

Highly advanced techniques in relation to the formation of fine magnetic particles, high density filling of a coating layer with fine magnetic particles, leveling of a coating layer and formation of a far thinner magnetic layer are employed in the production of coating type magnetic tapes capable of corresponding to such high density recording.

Further, thin film type magnetic tapes, each comprising a magnetic layer which is a metallic thin film formed by oblique deposition or sputtering, have been commercialized.

In the coating type magnetic tapes, the selection of magnetic particles to be used is especially important in order to attain sufficient electromagnetic conversion of signals within a short wavelength range corresponding to high density recording. To obtain improved magnetic particles which can be suitably used for a magnetic tape capable of recording signals with short wavelengths, the improvement of magnetic properties, typically, the improvements of coercive force and saturation magnetization are developed, together with the formation of far finer magnetic particles. In the production of high density recording magnetic tapes, needle-shaped metallic magnetic particles with a particle size of 100 nm or so in the major axial direction are now mainly used, instead of the magnetic particles of ferromagnetic iron oxide, cobalt-modified ferromagnetic iron, chrome oxide or the like, which have hitherto been used in audio tapes and household video tapes.

For example, JP-A-2001-181754 and JP-A-2002-056518 disclose substantially granular or ellipsoidal rare earth-iron-based magnetic particles with a number average particle size of 5 to 200 nm, which comprise a rare earth element and iron or iron-based transition element, and which have a coercive force of about 200 kA/m.

WO 03/079332A1 and WO 03/079333A1 disclose substantially granular iron nitride-based magnetic particles with a number average particle size of 5 to 50 nm, which comprise a rare earth element, iron or iron-based transition element and nitrogen, and these publications also discloses magnetic particles having a coercive force of 210 kA/m or more.

JP-A-2001-181754 discloses a magnetic recording medium comprising a non-magnetic substrate and a magnetic layer formed on the non-magnetic substrate, and this magnetic layer contains a binder and magnetic particles with a particle size of 5 to 200 nm which comprise a rare earth element, silicon, and iron or iron-based transition metal element.

JP-A-06-274847, JP-A-06-282835 and JP-A-2003-272123 disclose magnetic recording media each comprising a magnetic layer in which the orientation structure of magnetic particles is regulated so as to improve the electromagnetic converting performance.

JP-A-06-274847 and JP-A-06-282835 disclose magnetic recording media each of which comprises a magnetic layer with a thickness of 1 μm or less formed mainly from plate-shaped ferromagnetic hexagonal ferrite particles as magnetic powder, in order to exhibit high electromagnetic converting performance to signals within a wide recording wavelength range including signals with from short wavelengths to long wavelengths. These magnetic recording media are so designed as to establish relationships of Hc₁>Hc₂>Hc₃ and Hc₂>Hc₁>Hc₃, provided that the coercive force in the machine direction is Hc₁; the coercive force in the vertical direction, Hc₂; and the coercive force in the transverse direction, Hc₃. JP-A-06-274847 discloses an example of recording media in which the ratio of the coercive force Hc₁ in the machine direction to the coercive force Hc₃ in the transverse direction is 2.2 or more, and in which the average particle size of the magnetic particles is preferably about 30 to about 100 nm; and the aspect ratio, preferably 3 to 7.

JP-A-2003-272123 discloses a magnetic recording medium which has a magnetic layer with a thickness of 300 nm or less containing granular rare earth-transition metal-based magnetic particles with an average particle size of 5 to 100 nm, in order for the magnetic recording medium to exhibit high outputs in electromagnetic conversion of signals with short wavelengths. In this magnetic recording medium, the ratio of the coercive force in the machine direction to that in the transverse direction is 1.20 or more, preferably 1.25 or more, usually up to 1.35.

JP-A-2004-005896 discloses a magnetic tape comprising a non-magnetic substrate, a primer layer which contains non-magnetic particles and which is formed on one surface of the non-magnetic substrate, a magnetic layer which contains magnetic particles and which is formed on the primer layer, and a backcoat layer which contains non-magnetic particles and which is formed on the other surface of the non-magnetic substrate. This magnetic tape is characterized in that the magnetic layer with a thickness of 0.09 μm or less contains plate-shaped, granular or ellipsoidal magnetic particles with a particle size of 5 to 50 nm, and that at least one of the primer layer and the backcoat layer contains non-magnetic plate-shaped particles with a particle size of 10 to 100 nm.

JP-A-2002-056518 discloses a magnetic recording medium comprising a non-magnetic substrate and a magnetic layer which is formed on the non-magnetic substrate and which contains a binder and magnetic particles with a particle size of 5 to 200 nm comprising a rare earth element and iron or an iron-based transition metal element.

WO 03/079332A1 discloses a magnetic recording medium with a total thickness of less than 6 μm, comprising a non-magnetic substrate, a non-magnetic primer layer and magnetic layer(s) which are formed on one surface of the non-magnetic substrate in this order, and a backcoat layer which is formed on the other surface of the non-magnetic substrate, and characterized in that an uppermost magnetic layer of the magnetic layer(s) contains substantially granular rare earth-iron-based magnetic particles having a number average particle size of 5 to 50 nm and an average axial ratio of 1 to 2, which mainly comprise a rare earth element and iron or an iron-based transition metal. This publication also discloses a magnetic recording medium comprising an uppermost magnetic layer which contains rare earth-iron-based magnetic particles each having a core portion comprising Fe₁₆N₂.

This WO publication also discloses a magnetic tape cartridge which achieves a high track density as follows: a magnetic tape having servo signals recorded thereon is assembled in a one-reel type cartridge to provide the magnetic tape cartridge which allows data tracks to be traced by the servo signals to enable the high track density. Further, even a magnetic tape comprising an upper magnetic layer with a thickness of 0.09 μm or less can realize high reproducing output (high C) and a high ratio (high C/N) of reproducing output to noises, by employing, as a reproducing head, a magnetoresistance type magnetic head (or MR head) mounted thereon.

WO 03/079333A1 discloses a magnetic tape which is improved in servo tracking performance by forming a lower magnetic layer for use in recording servo signals, on the magnetic recording medium of WO 03/079332A1 to improve the output of servo signals, and also discloses a magnetic tape cartridge comprising the same magnetic tape.

However, it is clearly known that the electromagnetic converting performance such as reproducing output (C) and a ratio of reproducing output to noises (C/N), evaluated by using a MR head, has not attained expected values which are estimated from the coercive forces and the average particle sizes of the fine magnetic particles described in the foregoing patent publications.

### SUMMARY OF THE INVENTION

An object of the present invention is to provide a high recording density magnetic tape capable of corresponding to mass storage of 1 TB or more and achieving a high ratio of reproducing output/noises (C/N) for signals particularly within a short wavelength range, by solving the foregoing problems.

The present inventors have intensively researched a method of improving electromagnetic converting performances, especially a C/N ratio, and have finally discovered that a coercive force Hc_{T} in the transverse direction to which any importance hitherto has not been attached is an important factor, as well as a coercive force Hc_{M} in the machine direction which has attracted attentions as a important factor so far. To sum up, they have found out that the larger Hc_{M}, the better, and the smaller Hc_{T}, the better, and that a magnetic recording tape having a larger Hc_{M} and a smaller Hc_{T} makes it possible to increase an output C and decrease noises N when recording signals with short wavelengths, to achieve high recording performance for signals with short wavelengths. More specifically, the ratio of a coercive force Hc_{M} in the machine direction of a tape to a coercive force Hc_{T} in the transverse direction thereof is found to be important for improvement of electromagnetic converting performance, particularly the ratio of C/N.

To achieve the above object, the present invention provides a magnetic tape comprising a non-magnetic substrate and at least one magnetic layer formed on one surface of the non-magnetic substrate, wherein the magnetic particles contained in an uppermost magnetic layer of the magnetic layer(s) are substantially granular particles with a particle size of 30 nm or less, and the ratio of a coercive force Hc_{M} in the machine direction to a coercive force Hc_{T} in the transverse direction, [Hc_{M}/Hc_{T}], is at least 2.2.

When the particle size of the magnetic particles in the uppermost magnetic layer is 20 nm or less, the ratio of C/N is more improved.

### BRIEF DESCRIPTION OF THE DRAWINGS

FIG. 1 is a sectional view of a magnetic layer, which schematically illustrates the magnetization of the magnetic layer on which signals are magnetically recorded.

FIG. 2 is a diagram showing a model of magnetization reversal on the surface of the magnetic layer when signals are magnetically recorded.

FIG. 3, consisting of FIGS. 3(a) and 3(b), shows sectional views of magnetic layers, schematically illustrating the magnetization of the magnetic layers, when signals are magnetically recorded on the magnetic layers having different values of Hc_{M}/Hc_{T}, respectively, wherein the value of Hc_{M}/Hc_{T} of the magnetic layer shown in FIG. 3(a) is 2.2 or more, while the value of Hc_{M}/Hc_{T} of the magnetic layer shown in FIG. 3(b) is less than 2.2.

FIG. 4 is a graph showing a relationship between Hc_{M}/Hc_{T} and C/N.

### DETAILED DESCRIPTION OF THE INVENTION

As a result of the intensive investigation of the relationship between the ratio of a coercive force in the machine direction of a magnetic tape to a coercive force in the transverse direction thereof and the ratio of a reproducing output from the magnetic tape to noises, (C/N), it is found that the value of C/N increases when the ratio of the coercive force in the machine direction to the coercive force in the transverse direction is 2.2 or more. The ratio of the coercive force in the machine direction to the coercive force in the transverse direction is preferably 2.5 or more, more preferably 3.0 or more. Ideally, the value of this ratio is infinite, however, it is 10 or less in the state of the present art. The reason why the value of this ratio is 10 or less in the state of the present art is that the rotation of magnetic particles is hindered, because (1) the shapes of the magnetic particles are not perfect sphere; (2) the magnetic layer contains carbon black and a filler (e.g. alumina) other than the magnetic particles; and (3) the magnetic particles are non-homogenously dispersed, and therefore, it is difficult to completely orient the easy axes of magnetization, of the magnetic particles toward the machine direction.

According to the bench tests therefor, it is found that a coated magnetic layer should be oriented and dried in a magnetic field of 0.7 T or more in order to adjust the ratio of a coercive force in the machine direction to a coercive force in the transverse direction to 10.

While not to be bound by any of theories, the reason why a sufficient value of C/N for signals within a short wavelength range is obtained from the magnetic recording tape of the present invention may be considered as follows:

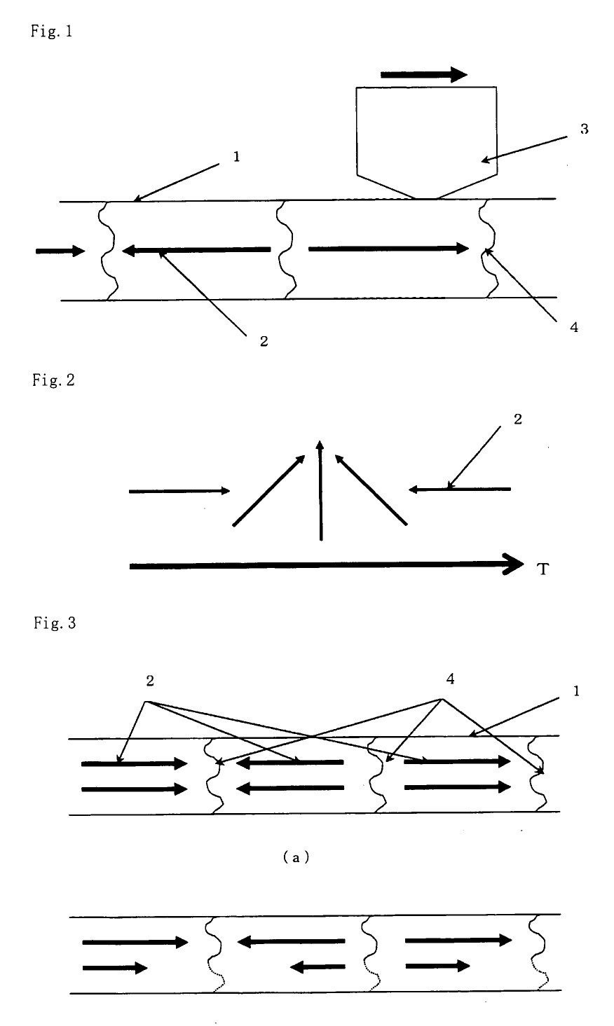

When the signals recorded on a magnetic tape along the machine direction are magnetized in the reverse direction by a magnetic head as shown in FIG. 1, the direction of magnetization rotates with time to cause magnetization reversal as shown in FIG. 2. The rotational direction of magnetization is possibly to the transverse direction or a direction vertical to the layer surface. When the upper magnetic layer is extremely thin as in the present invention, the rotational direction of magnetization is considered to be the transverse direction. This is because, when the magnetization arises in a direction vertical to the layer surface, a demagnetizing field becomes larger. Therefore, a magnetic layer having a small coercive force Hc_{T} in the transverse direction facilitates magnetization reversal even in a weak magnetic field which is created by a magnetic head. Accordingly, magnetization reversal easily takes place also in a portion distant from the magnetic head (i.e., the lower portion of the uppermost magnetic layer). In other words, magnetization reversal is easy and possible in all the portions of the uppermost magnetic layer from the upper surface thereof to the lower surface thereof. Thus, the magnetic layer having a small coercive force Hc_{T} in the transverse direction can include more magnetic particles contributing to magnetic recording, and serves to increase an output (C) when signals with short wavelengths are recorded. As a result, the ratio of output to noises (C/N) is increased (see FIG. 3). Furthermore, the magnetic transition area (a critical area in which magnetization reversal occurs in the magnetic layer) becomes narrower as the value of Hc_{M}/Hc_{T} becomes larger. Therefore, the resultant magnetic tape is excellent in performance of recording signals with short wavelengths. Since the magnetic particles are single magnetic-domain particles, the magnetic transition area is not narrower than the particle size of the magnetic particles in the machine direction. When the particle size of the magnetic particles is 30 nm or less which is shorter than the wavelengths of signals to be recorded as in the present invention, the magnetic transition area becomes so narrow as 30 nm or less, in association with a decrease in particle size.

As the coercive force in the machine direction becomes larger, self demagnetization due to a demagnetizing field becomes smaller. Therefore, as the ratio of a coercive force Hc_{M} in the machine direction to a coercive force Hc_{T} in the transverse direction, [Hc_{M}/Hc_{T}], becomes larger, the value of C/N becomes larger. The value of Hc_{M}/Hc_{T} is preferably 2.2 or more, more preferably 2.5 or more, still more preferably 3.0 or more. When the value of Hc_{M}/Hc_{T} is less than 2.2, the effect of improving the C/N is insufficient. On the other hand, when it exceeds 10, the effect of improving the C/N is saturated. Therefore, the value of Hc_{M}/Hc_{T} is generally 10 or less.

The coercive force Hc_{M} or Hc_{T} referred to in the present invention is measured according to a standard method under the conditions of 25° C. and an external magnetic field of 1,273.3 kA/m, using a sample vibration magnetometer manufactured by Toei Kogyo Kabushikikaisha. A sample to be measured is prepared by laminating 20 magnetic tapes and punching the laminated tapes to obtain the sample with a diameter of 8 mm. The measured value is an average of 10 coercive forces in the machine direction of the magnetic tape or 10 coercive forces in the transverse direction thereof.

The coercive force of a magnetic tape has hitherto simply meant Hc_{M} referred to in the present invention. This is because a coercive force (Hc_{M}) in the machine direction of a magnetic tape has an influence on a decrease in output due to a demagnetizing field which occurs when signals with short wavelengths are recorded. When the Hc_{M} is increased, the degree of a decrease in output due to a demagnetizing field can be reduced, so that the output of signals with short wavelengths can be improved. For this reason, importance is attached on only the coercive force in the machine direction (Hc_{M}). However, other than this fact, the present inventors have discovered a fact that it is effective to decrease a coercive force (Hc_{T}) in the transverse direction of a magnetic tape, in order to improve the values of C and C/N for signals within the short wavelength range, which is required for a magnetic recording medium capable of corresponding to high density mass storage exceeding 1 TB (exceeding substantially 1.0 GB/inch²). They further have firstly discovered that it is very effective to adjust the value of (Hc_{M}/Hc_{T}) by separately controlling the coercive forces in the machine direction and the transverse direction, in order to achieve the object of the present invention.

While a means for adjusting the value of (Hc_{M}/Hc_{T}) to 2.2 or more is not particularly limited in the present invention, the following methods are preferably employed.

(1) The shape of magnetic particles is so selected that the value of (Hc_{M}/Hc_{T}) can be increased by decreasing the coercive force in the transverse direction, while the coercive force in the machine direction is unchanged. Preferably, substantially granular magnetic particles are used.

The substantially granular magnetic particles to be used in the present invention are spherical or substantially spherical, ellipsoidal or substantially ellipsoidal, polygonal or substantially polygonal, or plate-shaped or substantially plate-shaped particles, each of which has an axial ratio (major axis/minor axis) of less than 2. The axial ratio of the particles is preferably 1.5 or less, more preferably less than 1.5.

The major axis of a substantially spherical, ellipsoidal or substantially ellipsoidal, or polygonal or substantially polygonal particle is an axis having a maximum value among the dimensions of the axes of the particle in all the directions, while the major axis of a plate-shaped or substantially plate-shaped particle is a plate size in the plane direction. The minor axis of the substantially spherical, ellipsoidal or substantially ellipsoidal, or polygonal or substantially polygonal particle is an axis having a maximal value among the axes of the particle vertical to the direction of the major axis, while the minor axis of the plate-shaped or substantially plate-shaped particle is the thickness of the plate-shaped particle.

To decrease the value of Hc_{T} relative to Hc_{M}, the upper limit of the particle size of fine granular magnetic particles is preferably 30 nm or less, more preferably 20 nm or less, still more preferably 15 nm or less, far more preferably less than 15 nm. On the other hand, the lower limit of the particle size is preferably 3 nm or more, more preferably 5 nm or more, still more preferably 8 nm or more. When the particle size is less than 3 nm, such magnetic particles are hardly dispersed in a magnetic coating composition, so that the value of Hc_{T} relatively increases. When the particle size exceeds 30 nm, noises of the resultant magnetic tape increases.

While the present invention dose not necessarily exclude magnetic powder containing magnetic particles with a particles size of 30 nm or more, the number average particle size of such magnetic powder is preferably 30 nm or less.

(2) Preferably, magnetic particles which are less or hardly sintered are used.

Preferably, the substantially granular magnetic particles to be contained in the uppermost magnetic layer of the magnetic recording tape of the present invention are magnetic particles each having an outer layer portion and a core portion, in which at least one of elements whose oxides are not reduced with hydrogen at a temperature of 600° C. or lower, such as rare earth elements, aluminum, silicon, zirconium and titanium (especially rare earth elements, aluminum or silicon) is mainly contained in the outer layer portion of the particle, and in which iron or an iron-based transition element (transition element mainly comprising iron) and nitrogen are mainly contained in the core portion of the particle. This structure of the outer layer portion of each magnetic particle is effective to prevent the sintering of the magnetic particles in the course of preparation of magnetic particles, so that the value of Hc_{T} can be decreased relative to Hc_{M}. More preferable is iron nitride-based magnetic powder in which each particle has a core portion containing a Fe₁₆N₂ phase. Preferably, the composition distribution of nitrogen, etc. of each of the magnetic particles is small.

(3) Preferably, the squareness of the magnetic recording tape in the machine direction should be controlled. To increase the coercive force Hc_{M} in the recording direction, i.e. the machine direction and not to lower the electromagnetic converting performance, the squareness of the tape in the machine direction is preferably 0.75 or more. The larger the squareness, the better. While the ideal squareness is theoretically 1, the limit of the squareness is practically about 0.95. Further, the smaller the SFD (switching field distribution or anisotropic magnetic field distribution) of the magnetic tape, the better. SFD is preferably 1.0 or less, more preferably 0.7 or less. The use of magnetic particles having a more uniform particle size, i.e. a narrow particle size distribution is effective to improve SFD. In a magnetic tape having a smaller SFD, the coercive force Hc_{T} in the transverse direction of the tape is effectively decreased while the squareness in the machine direction is the same. Magnetic particles with an uniform particle size can be homogenously dispersed to produce a similar effect.

To achieve these effects, a strong magnetic field for orientation (for example, 0.5 T or more) is applied to an uppermost magnetic layer coated, and then, the application of an uniform magnetic field for orientation (for example, 0.1 T or more) is continued until the uppermost magnetic layer is substantially dried.

To apply an uniform magnetic field, there is employed a method of disposing a plurality of repulsive magnets, or a method of using a solenoid, or otherwise, a method of employing both repulsive magnets and a solenoid in combination, and any of these methods may be employed. The method of disposing a plurality of repulsive magnets has an advantage in low running cost, but has a disadvantage in that a magnetic field is directed vertically to the surface of a magnetic medium layer, or no magnetic field is applied to some portions thereof, or magnetization reversal occurs, between each of the repulsive magnets. Therefore, it is necessary to adequately position the magnetic layer to be dried in an area where a magnetic field is created in the machine direction of the magnetic tape. On the other hand, the method of using a solenoid has a disadvantage in high running cost for electric power or the like, but has an advantage in that a magnetic field for orientation is correctly directed to the machine direction of a magnetic recording tape. Therefore, the orientation of the easy axes of magnetization, of the magnetic particles toward the machine direction of the magnetic tape is facilitated. As a result, advantageously, the ratio of a coercive force in the machine direction of the tape to a coercive force in the transverse direction thereof, i.e. [Hc_{M}/Hc_{T}] becomes very large.

(4) To further decrease the value of Hc_{T} relative to the value of Hc_{M}, it is effective to improve the dispersibility of magnetic particles in a coating composition. To achieve this improvement, any of the known methods which have been employed to improve the dispersibility of fine magnetic particles can be employed, or some of these methods may be optionally used in combination.

In the preparation of a magnetic coating composition, preferably, magnetic particles are previously mixed with a dispersant and a resin and stirred at a high speed before kneading the magnetic particles, so as to sufficiently disperse the magnetic particles in the dispersing step. In the kneading step, a pressure kneader or a continuous twin-screw kneader capable of applying a large shear force is preferably used so as to homogenously mix the magnetic particles with the resin. When a common kneader is used, the batch of the magnetic particles is properly adjusted. The dispersion of the magnetic particles may be done in an ordinary sand-mill type disperser, using dispersing media. As the dispersing media, beads with a particle size of less than 1 mm which contain titania or zirconia as a main component are preferably used, although the conventional materials may be used. Such beads have a small particle size and can have a higher dispersing ability as their specific gravities becomes larger, and thereby facilitates the orientation of the magnetic particles. As a result, the coercive force in the transverse direction of the magnetic tape is advantageously decreased.

Otherwise, the surfaces of the magnetic particles may be treated with a known surface-treating agent for easy dispersion.

A resin to be used as a binder may be any of known resins having functional groups which act to improve the dispersibility of magnetic particles.

In the present invention, each of the foregoing methods may be employed alone, or preferably in combination with some other methods, to provide a magnetic recording tape having a predetermined value of [Hc_{M}/Hc_{T}]. In this regard, the method of controlling the value of [Hc_{M}/Hc_{T}] is not limited to any of the methods (1) to (4), and any of the known methods may be optionally used in combination.

Hereinafter, the components of the magnetic recording tape of the present invention will be described in detail.

<Magnetic Particles>

As the substantially granular fine magnetic particles, rare earth-iron-boron-based magnetic particles having an average particle size of 5 to 200 nm and a coercive force of 80 to 400 kA/m (JP-A-2001-181754) and rare earth-iron-based magnetic particles (JP-A-2002-56518) are known.

Also, there are proposed iron nitride-based magnetic particles each of which has a Fe₁₆N₂ phase as a main phase, and which has a BET specific surface area of 10 m²/g or more (JP-A-2000-277311). The coercive force obtained from these magnetic particles is as small as less than 200 kA/m, and the particle size thereof is unknown.

There are further proposed (rare earth, aluminum or silicon)-iron nitride-based magnetic particles which have an average particle size of 5 to 50 nm and are excellent in dispersibility in a coating composition and oxidation stability, and which have a coercive force as high as 210 kA/m or more because at least one element selected from the group consisting of rare earth elements, aluminum and silicon which have a high sintering-preventive effect, high coercive force-obtaining effect, and high stability (anticorrosion)-improving effect is mainly contained in the outer layer portion of each magnetic particle (WO 03/079332A1 and WO 03/079333A1).

Among the above-mentioned magnetic particles, the substantially granular iron nitride-based fine magnetic particles having a particle size of 30 nm or less and an axial ratio (major axis/minor axis) of less than 2 are preferred as the fine magnetic particles for the uppermost magnetic layer of the present invention. More preferred are iron nitride-based fine magnetic particles each of which mainly contains, in the outer layer portion, at least one element selected from the elements whose oxides are not reduced with hydrogen at a temperature of 600° C. or lower, such as rare earth elements, aluminum, silicon, zirconium, titanium and the like (particularly rare earth elements, aluminum or silicon), and each of which mainly contains a nitride of iron or an iron-based transition metal in the core portion. Still more preferred are iron nitride-based fine magnetic particles each of which contains, in the outer layer portion, at least one element selected from rare earth elements, aluminum and silicon, and each of which contains Fe₁₆N₂ in the core portion. Herein, examples of the iron nitride-based fine magnetic particles each of which has Fe₁₆N₂ in the core portion also include magnetic particles in each of which a part of iron (Fe) of the Fe₁₆N₂ phase is substituted by an element other than iron, and a part of nitrogen (N) thereof, by an element other than nitrogen, and in each of which the stoichiometric amounts of iron and nitrogen are contained in a ratio other than 16/2.

The reason why the outer layer portion of each magnetic particle mainly contains an element selected from the elements whose oxides are not reduced with hydrogen at a temperature of 600° C. or lower, such as rare earth elements, aluminum, silicon, zirconium, titanium and the like is that such an element prevents the sintering of the particles in the hydrogen reduction step, which is one of the steps for preparing the magnetic particles, to facilitate the preparation of the iron nitride-based fine magnetic particles with a small particle size. The reason why the core portion of each magnetic particle mainly contains a nitride (especially, a Fe₁₆N₂ phase) is that such a nitride makes it easy to provide iron nitride-based fine magnetic particles having a high coercive force and high saturation magnetization.

If needed, an element effective to improve the dispersibility of magnetic particles, such as aluminum, silicon, phosphorous, zirconium or the like, or a compound thereof may be contained in or adsorbed to the surfaces of the magnetic particles. If further needed, carbon, calcium, manganese, magnesium, barium or strontium, or a compound thereof may be contained in or adsorbed to the surfaces of the magnetic particles.

Examples of the rare earth elements include yttrium, ytterbium, cesium, praseodymium, lanthanum, samarium, europium, neodymium, terbium and the like. Among these elements, yttrium, samarium and neodymium show high particle shape-keeping effects during the reduction step, and therefore, at least one of these elements is preferably used.

The particle size is preferably 30 nm or less, more preferably 20 nm or less, still more preferably less than 15 nm. When the particle size is 3 nm or more, such magnetic particles are easily dispersed in the preparation of a coating composition. The particle size is preferably 5 nm or more, more preferably 8 nm or more.

The scope of the present invention does not necessarily exclude magnetic particles with a particle size exceeding 30 nm and magnetic particles with a particle size of less than 3 nm. Even when such magnetic particles are contained, the average particle size preferably should be 30 nm or less, and the lower limit of the average particle size should be preferably 3 nm or more.

The axial ratio (major axis/minor axis) of the particle is preferably less than 2, because the properties of the magnetic particles as a filler are improved. It is more preferably 1.5 or less, still more preferably less than 1.5. The scope of the present invention does not necessarily exclude magnetic particles with an axial ratio of 2 or more. Even when such magnetic particles are contained, the average axial ratio preferably should be less than 2.

In this regard, the particle size is the major axis of a particle which is determined from a photograph taken using a transmission electron microscope (TEM) at a magnification of 200,000 times. The average particle size is determined by measuring the particle sizes (major axes) of 50 particles on this photograph, and averaging the resultant 50 particle sizes. The axial ratio is the ratio of the major axis to the minor axis (major axis/minor axis) as defined above, which are measured from the TEM photograph. The average axial ratio is determined by calculating the axial ratio of each of 50 particles, and averaging the 50 axial ratios. The particle size of magnetic particles in a magnetic tape is determined by photographing the longitudinal section of the tape (cut along the machine direction) with a scanning electron microscope (SEM) at a magnification of 200,000 times.

The total content of a rare earth element, aluminum, silicon, zirconium, titanium, etc. mainly contained in the outer layer portion of each magnetic particle based on the content of iron is preferably 0.2 to 20 atomic %, more preferably 2 to 10 atomic %. When the total content of some of a rare earth element, aluminum, silicon, zirconium, titanium, etc. is too small, coarse particles tends to form because of the sintering of particles in the reduction step, so that the particle size distribution becomes poor with the result that the coercive force (Hc_{T}) in the transverse direction undesirably becomes larger. When the total content of a rare earth element, aluminum, silicon, zirconium, titanium, etc. is too large, the saturation magnetization tends to excessively lower. The content of the rare earth element is more preferably 0.2 to 15 atomic %, still more preferably 2 to 10 atomic %. When the content of the rare earth element is too large, not only the cost is raised, but also the saturation magnetization tends to excessively lower. When the content of the rare earth element is too small, the contribution of magnetic anisotropy due to the rare earth element sometimes becomes poor.

The content of nitrogen to the content of iron is preferably 1.0 to 20 atomic %, more preferably 3 to 13 atomic %, still more preferably 8 to 13 atomic %. When the content of nitrogen is too small, the amount of a Fe₁₆N₂ phase formed is small, and the contribution of magnetic anisotropy becomes poor, so that the effects of increasing the coercive force and saturation magnetization (particularly the coercive force) become lower. When the content of nitrogen to the content of iron is too large, iron nitrides such as Fe₄N and Fe₃N which are poor in coercive force and saturation magnetization, and non-magnetic nitrides tend to form. Thus, the effects of increasing the coercive force and saturation magnetization become poor. In particular, the saturation magnetization excessively lowers.

The coercive force in the machine direction of the upper magnetic layer is preferably 160 to 400 kA/m, more preferably 200 to 400 kA/m, still more preferably 220 kA/m or more, far more preferably 250 kA/m or more. The coercive force within this range is preferred, because it is difficult to sufficiently decrease the recording wavelength at a coercive force of less than 160 kA/m, and because the recording with a magnetic head sometimes becomes insufficient at a coercive force exceeding 400 kA/m. Therefore, the coercive force is preferably 380 kA/m or less, more preferably 350 kA/m or less.

The BET specific surface area of the magnetic particles is preferably 40 to 200 m²/g, more preferably 50 m²/g or more, still more preferably 60 m²/g or more. The BET specific surface area within this range is preferred, because it is difficult to increase the coercive force at a BET specific surface area of less than 40 m²/g, and because the dispersibility of the magnetic particles in a coating composition becomes poor or the magnetic particles become chemically unsatble at a BET specific surface area exceeding 200 m²/g. The BET specific surface area is more preferably 100 m²/g or less.

The saturation magnetization of the magnetic particles is preferably 70 to 160 Am²/kg (70 to 160 emu/g). When it is less than 70 Am²/kg, the reproducing output becomes lower, while, when it exceeds 160 Am²/kg, the cohesive force of the magnetic particles becomes larger, so that, sometimes, it takes too long in dispersing the magnetic particles in the preparation of a coating composition. The saturation magnetization is more preferably 80 Am²/kg or more, still more preferably 90 Am²/kg or more. When it is 140 Am²/kg or less, the magnetic particles are easily dispersed in the preparation of the coating composition, and the aged deterioration of saturation magnetization is a little.

As described above, the rare earth-iron nitride-based magnetic particles of the present invention show excellent properties as magnetic particles to be used in a magnetic recording tape, and are also excellent in preservation stability. In case where the magnetic particles or magnetic recording tapes comprising the same are stored under an environment of high temperature and high humidity, the magnetic characteristics thereof such as saturation magnetization and the like hardly deteriorate. Therefore, the magnetic particles of the present invention are suitable for use in high density recording magnetic tapes.

Next, the preparation of the foregoing iron nitride-based magnetic particles is explained.

The iron nitride-based magnetic particles, each containing a rare earth element, aluminum and/or silicon, of the present invention are prepared using, as a starting material, an iron oxide or an iron hydroxide such as hematite, magnetite, goethite or the like, as described in WO 03/079332A1 and WO 03/079333A1. The particles of such an iron oxide or hydroxide are coated with at least one element selected from rare earth elements, aluminum and silicon, and are reduced by heating at a temperature of 300 to 600° C. under an atmosphere of a reductive gas such as hydrogen or the like, and then are nitrided at a temperature of 100 to 300° C. under a gaseous atmosphere containing ammonia.

When the particle size distribution of the iron oxide or hydroxide as the starting material is smaller, preferably, the coercive force (Hc_{T}) in the transverse direction is easily decreased. Preferably, the particles are nitrided at a low temperature over a long period of time so as to suppress the distribution of nitrogen among the particles.

Further, aluminum, silicon, phosphorous, zirconium, carbon, calcium, magnesium, barium, strontium or the like may be adsorbed to or contained in the iron nitride-based magnetic particles thus prepared, each containing the rare earth element, aluminum and/or silicon. As this treating method, magnetite particles coated with a rare earth element or the like, prepared by the method described in WO 03/079333A1, are immersed in an aqueous solution of an aluminum salt or the like to adsorb aluminum onto the surfaces of the magnetite particles.

In case where hexagonal barium ferrite magnetic particles are used as the magnetic particles, the saturation magnetization of the hexagonal barium ferrite magnetic particles is preferably 40 to 70 Am²/kg (40 to 70 emu/g).

The plate size (i.e. the maximum dimension in the plane direction) is preferably 3 to 30 nm, more preferably 5 to 20 nm. When the plate size is less than 3 nm, the surface energies of the particles are increased to make it difficult to disperse the particles in a coating composition. When it exceeds 30 nm, particle noises depending on the sizes of the particles become larger.

The plate-shape ratio (plate size/plate thickness) is preferably less than 2, more preferably 1.5 or less, still more preferably less than 1.5. When the plate-shape ratio is 2 or more, the following disadvantage arises:

Even though the plane faces of the plate-shaped magnetic particles are oriented in the machine direction of the uppermost magnetic layer by applying a magnetic filed in the machine direction, the plane faces of the plate-shaped magnetic particles fall vertically to the uppermost magnetic layer in the calendering step, which leads to a decrease in the value of Hc_{M}/Hc_{T}, or which leads to higher noises, since the plate-shaped magnetic particles penetrate the primer layer in the calendering step to disturb the interface between the uppermost magnetic layer and the primer layer.

The BET specific surface area of the hexagonal barium ferrite magnetic particles is preferably 1 to 100 m²/g.

As mentioned above, the present invention does not necessarily exclude magnetic particles with a particle size exceeding 30 nm or magnetic particles with a particle size of less than 3 nm. Even in such a case, the average particle size preferably should be 3 to 30 nm. The scope of the present invention does not necessarily exclude magnetic particles with an plate-shape ratio of 2 or more. Even in such a case, the average plate-shape ratio preferably should be less than 2.

In this regard, the particle size is a maximum plate size of a plate-shaped particle which is determined from a photograph taken using a transmission electron microscope (TEM) at a magnification of 200,000 times. The average particle size is determined by measuring the particle sizes (plate sizes) of 50 particles on the photograph, and averaging the resultant 50 particle sizes.

The plate-shape ratio is a ratio of the plate size to the plate thickness (plate size/plate thickness) which are measured from a TEM photograph. The average plate-shape ratio is determined by calculating the plate-shape ratios of 50 particles, and averaging the 50 plate-shape ratios. The average particle size of the magnetic particles formed in a tape-like shape is determined in the same manner as in the case of the iron nitride-based magnetic particles.

In case of the hexagonal barium ferrite magnetic particles, the coercive force in the machine direction of the upper magnetic layer is preferably 160 to 400 kA/m, more preferably 200 to 400 kA/m, still more preferably 220 kA/m or more, far more preferably 250 kA/m or more, for the same reason as above.

To achieve a higher C/N using a NR head, it is more preferable to use the foregoing substantially granular fine iron nitride-based magnetic particles.

<Non-Magnetic Substrate>

Any of the conventional substrates for magnetic recording tapes can be used as a non-magnetic substrate of the present invention. For example, a polyethylene terephthalate film, a naphthalene terephthalate film, an aromatic polyamide film, an aromatic polyimide film and the like can be used.

The thickness of the non-magnetic substrate is generally 2 to 5 μm, preferably 2 to 4.5 μm, more preferably 2 to 4 μm, which is varied depending on the end use. When it is less than 2 μm, the formation of such a film is difficult, and the strength of the resultant magnetic tape becomes poor. When it exceeds 5 μm, the recording capacity per one reel of the magnetic tape becomes smaller.

<Magnetic Layer>

The thickness of the uppermost magnetic layer is preferably 5 to 90 nm. When it is less than 5 nm, the formation of a magnetic layer with an uniform thickness is difficult. When it exceeds 90 nm, a decrease in reproducing output due to demagnetization depending on the thickness tends to occur.

When the thickness of the uppermost magnetic layer is so thin as 90 nm or less, a lower magnetic layer for recording servo signals may be provided under the uppermost magnetic layer through a non-magnetic primer layer.

A binder resin (hereinafter simply referred to as a binder) to be contained in the magnetic layer, and the amount of the binder resin may be the same as in any of the conventional magnetic tapes. For example, any of the binders described in WO 03/079332A1 and WO 03/079333A1 may used in such an amount as described in either of these publications. When two or more different resins are used in combination as a binder, preferably, the polarities of the functional groups of the resins are the same. Above all, the combination of —SO₃M groups is preferred.

Preferably, a vinyl chloride resin having a functional group such as a —SO₃M group is compounded with a polyurethane resin having a functional group such as a —SO₃M group, or otherwise, a plurality of polyurethane resins having the same functional groups are compounded for use as a binder.

A thermocurable crosslinking agent such as polyisocyanate or the like is used in combination with the binder, so as to bond the functional groups in the binder to crosslink the magnetic layer. When the magnetic layer is applied on the primer layer by a wet-on-wet method, a part of polyisocyanate is spread and supplied from a coating composition for the primer layer. Therefore, the magnetic layer is crosslinked to some degree, even if polyisocyanate is not used in combination with the binder.

Each of the conventional abrasive materials having Mohs hardness of 6 or more, such as α-alumina, α-iron oxide and the like, may be added alone or in combination with other abrasive materials selected therefrom, to the magnetic layer. The number average particle size of such an abrasive material is usually 10 to 150 nm. If needed, plate-shaped particles with a number average particle size of 10 to 100 nm may be added.

To improve the electrical conductivity and the surface lubricity, conventional carbon black (CB) with a number average particle size of 10 to 100 nm may be added to the magnetic layer of the present invention. To improve the electrical conductivity, plate-shaped ITO particles with a number average particle size of 10 to 100 nm may be further added to the magnetic layer.

When the non-magnetic particles such as an abrasive material, carbon black and the like to be contained in the magnetic layer have small particle size distributions, the coercive force (Hc_{T}) in the transverse direction of the magnetic tape preferably becomes smaller.

<Preparation of Magnetic Coating Composition>

Preferably, a coating composition is prepared by the following steps, so as to fill a coating layer with the very fine magnetic particles having an average particle size of 30 nm or less at a high density and to well disperse them in the coating layer.

Prior to the kneading step, granular magnetic particles are milled with a mill, and are then mixed with an organic acid such as a phosphoric acid or the like and a binder resin with a mixer, to surface-treat the magnetic particles and mix them with the binder resin. In the kneading step, a continuous twin-screw kneader is used to form a knead-mixture having a solid content of 80 to 85 wt. % and containing the binder resin in a proportion of 17 to 30 wt. % based on the weight of the magnetic particles. After the kneading step, the continuous twin-screw kneader or other dilution apparatus is used to knead and dilute the knead-mixture while adding a binder resin solution and/or a solvent at least once, and the diluted knead-mixture is dispersed with a fine media rotation type disperser such as a sand mill or the like. In some cases, the non-magnetic particles with a particle size larger than that of the magnetic particles contained in the magnetic layer interrupt the shear stress, i.e. the dispersing force, from the dispersing media, and hinder the dispersion of the magnetic particles. Therefore, preferably, the non-magnetic particles are dispersed separately from the magnetic particles to form a slurry, which is then mixed with a coating composition which has the magnetic particles dispersed therein. Thus, a coating composition for magnetic layer is provided. Preferably, the resultant magnetic layer formed form this coating composition can have a smaller coercive force (Hc_{T}) in the transverse direction.

<Orientation in Magnetic Field>

The orientation of the uppermost magnetic layer in a magnetic field may be conducted by any of the known orientation methods. After the coating step, repulsive magnets are used to apply a strong magnetic field (for example, 0.5 T or more) to the uppermost magnetic layer for the orientation of the same, and subsequently, a solenoid electromagnet is used to continuously apply an uniform magnetic field (for example, 0.1 T or more) to the uppermost magnetic layer until the uppermost magnetic layer is substantially dried.

To lower the running cost, the method of disposing a plurality of repulsive magnets may be employed, although the reversal of the magnetic field is repeated. Therefore, it is preferable to dry the uppermost magnetic layer in an area where an uniform magnetic field can be created.

<Primer Layer>

Preferably, a primer layer is provided in order to improve the smoothness of the uppermost magnetic layer, reduce the fluctuation in thickness and improve the durability. The thickness of the primer layer is preferably 0.3 to 0.9 μm. When it is less than 0.3 μm, the effects of reducing the fluctuation in the thickness of the magnetic layer, and of improving the durability of the magnetic layer are insufficient. When it exceeds 0.9 μm, the total thickness of the resultant magnetic recording tape is too large, so that the recording capacity per one reel of the magnetic tape becomes smaller.

Preferably, the primer layer is non-magnetic so as not to disturb the magnetically recorded signals on the uppermost magnetic layer.

In the primer layer, there are used known non-magnetic particles such as titanium oxide, iron oxide, aluminum oxide, silicon oxide, zirconium oxide or the like, and carbon black. Usually used in the primer layer are non-magnetic iron oxide particles having a number average major axis of 0.05 to 0.2 μm and a number average minor axis of 5 to 100 nm, and carbon black having a number average particle size of 0.01 to 0.1 μm, and if needed, aluminum oxide particles having a number average particle size of 10 to 500 nm, particularly 10 to 100 nm.

As described in WO 03/079332/A1 and WO 03/079333/A1, plate-shaped aluminum oxide particles and iron oxide particles with number average plate sizes of 10 to 100 nm are used in a thin primer layer with a thickness of 0.9 μm or less. The use of such very fine plate-shaped non-magnetic particles is effective to provide a thin coating layer with a thickness of 0.9 μm or less, which has little fluctuation in thickness and has a surface smoothness. Since a coating layer in which the plate-shaped particles are superposed on one another is formed, the effect of reinforcing the coating layer in the plane surface direction is high, and simultaneously, the dimensional stability of the coating layer against changes in temperature and humidity becomes higher.

Not only aluminum oxide particles but also the oxides or compound oxides of a rare earth element such as cerium, zirconium, silicon, titanium, manganese, iron and the like can be used as the non-magnetic plate-shaped particles. To improve the electrical conductivity, plate-shaped ITO particles (e.g. indium-tin oxide) may be added. As the method of preparing the non-magnetic plate-shaped fine particles, the methods as described in WO 03/079332/A1 and WO 03/079333/A1 may be employed.

In this connection, as a binder resin to be used in the primer layer, the same resins as those used in the magnetic layer are used.

<Lubricant>

A conventional lubricant can be contained in the magnetic layer and/or the primer layer, in such an amount as conventionally used. For example, any of the known lubricants such as those described in WO 03/079332/A1 and WO 03/079333/A1 may be contained in the magnetic layer and/or the primer, in such an amount as described in these publication.

For example, when a higher fatty acid having 10 or more carbon atoms, such as myristic acid, stearic acid, palmitic acid or the like, and a higher fatty acid ester such as butyl stearate are contained in the primer layer, the friction coefficient of the resultant magnetic tape against a head, preferably, becomes smaller.

When a fatty acid amide such as an amide of palmitic acid, stearic acid or the like and a higher fatty acid ester are contained in the magnetic layer, the frictional coefficient of the resultant magnetic layer while being run, preferably, becomes smaller.

The intermigration of the lubricants of the magnetic layer and the primer layer therebetween may be allowed.

<Backcoat Layer>

To improve the running performance of the magnetic recording tape of the present invention, a backcoat layer may be provided on the other surface of the non-magnetic substrate as one component of the magnetic recording tape of the present invention (the other surface of the substrate reverse to the surface thereof having the magnetic layer formed thereon). The backcoat layer is formed by vapor deposition, sputtering, CVD (chemical vapor deposition) or coating, and usually comprises carbon black and a binder resin. Preferably, the thickness of the backcoat layer is 0.2 to 0.8 μm.

As the carbon black (CB), conventional carbon black particles with a small particle size, as of acetylene black, furnace black, thermal black or the like are used in combination with a small amount of carbon black particles with a large particle size. The number average particle size of carbon black with a small particle size is 5 to 200 nm, and that of carbon black with a large particle size is 300 to 400 nm. The surface roughness Ra of the backcoat layer is preferably 3 to 8 nm, more preferably 4 to 7 nm.

To improve the strength of the backcoat layer, the plate-shaped particles with a number average particle size of 10 to 100 nm, of aluminum oxide, or an oxide or a compound oxide of a rare earth element (e.g. cerium), zirconium, silicon, titanium, manganese, iron or the like may be added. To improve the electrical conductivity thereof, plate-shaped ITO particles may be added.

As a binder resin to be contained in the backcoat layer, a cellulose resin is preferably used in combination with a polyurethane resin. More preferably, a crosslinking agent such as a polyisocyanate compound is added to cure the binder resin.

<Organic Solvent>

Examples of organic solvents to be used in the preparation of the coating compositions for the magnetic layer, the primer layer and the backcoat layer include ketones such as methyl ethyl ketone, cyclohexane and methyl isobutyl ketone; ethers such as tetrahydrofuran and dioxane; esters such as ethyl acetate and butyl acetate; etc. Each of these solvents is used alone or in combination, and is further mixed with toluene or the like for use.

Here, the present invention and preferred embodiments thereof are summarized as below.

1. A magnetic tape comprising a non-magnetic substrate, and at least one magnetic layer which contains magnetic particles and a binder resin and which is formed on one surface of the non-magnetic substrate, wherein the magnetic particles contained in the uppermost magnetic layer of the magnetic layer are substantially granular particles with a particle size of 30 nm or less, preferably 20 nm or less, and the ratio of a coercive force in the machine direction of the uppermost magnetic layer to a coercive force in the transverse direction thereof, [(a coercive force in the machine direction)/(a coercive force in the transverse direction)], is at least 2.2.

2. The magnetic tape in which the coercive force in the machine direction of the uppermost magnetic layer is 160 to 400 kA/m, preferably 200 to 400 kA/m.

3. The magnetic tape in which the coercive force in the transverse direction of the uppermost magnetic layer is 16 to 180 kA/m, preferably 20 to 120 kA/m.

4. The magnetic tape in which the value of [(the coercive force in the machine direction of the uppermost magnetic layer)−(the coercive force in the transverse direction thereof)] is from 155 to 360 kA/m.

5. The magnetic tape in which the thickness of the uppermost magnetic layer is 0.09 μm or less.

6. The magnetic tape in which the product (Br.δ) of the residual magnetic flux density (Br) and the thickness (δ) of the uppermost magnetic layer is 0.0018 to 0.05 μTm.

7. The magnetic tape in which at least one primer layer containing non-magnetic particles and a binder resin is provided between the non-magnetic substrate and the uppermost magnetic layer.

8. The magnetic tape in which a backcoat layer is formed on the other surface of the non-magnetic substrate.

9. The magnetic tape in which the backcoat layer contains carbon black particles and a binder.

10. The magnetic tape which has a total thickness of less than 6 μm.

11. The magnetic tape in which each of the substantially granular magnetic particles contained in the uppermost magnetic layer comprises an outer layer portion and a core portion.

12. The magnetic tape in which the magnetic particles contained in the uppermost magnetic layer are substantially granular particles having a particle size of 20 nm or less and an axial ratio of less than 1.5.

13. The magnetic tape in which the particle size of the substantially granular magnetic particles contained in the uppermost magnetic layer is less than 15 nm, and the axial ratio of the particle is less than 1.5.

14. The magnetic tape in which at least one of the elements such as rare earth elements, aluminum, silicon, titanium and zirconium, whose oxides are not reduced at a hydrogen reduction temperature of 600° C. or lower (particularly, rare earth elements, aluminum and silicon) is mainly contained in the outer layer portion of each of the magnetic particles contained in the uppermost magnetic layer.

15. The magnetic tape in which the substantially granular magnetic particles contained in the uppermost magnetic layer are iron nitride-based magnetic particles, each of which has a core portion comprising an iron nitride phase formed by substituting the iron or a part of the iron with a transition metal element.

16. The magnetic tape in which the iron nitride phase of the core portion of each of the substantially granular iron nitride-based magnetic particles contained in the uppermost magnetic layer contains a Fe₁₆N₂ phase formed by substituting the iron or a part of the iron with a transition metal element.

In this regard, examples of the Fe₁₆N₂ phase include iron nitride phases which are formed by substituting a part of the iron (Fe) with an element other than iron, and substituting a part of the nitrogen (N) with an element other than nitrogen, and iron nitride phases in which the stoichiometric amounts of the iron and the nitrogen are contained in the ratios other than 16:2.

17. The magnetic tape in which the content of a rare-earth element in each of the substantially granular iron nitride-based magnetic particles contained in the uppermost magnetic layer is 0.05 to 20 atomic % based on the content of iron.

18. The magnetic tape in which the content of a rare earth element in each of the substantially granular magnetic particles contained in the uppermost magnetic layer is 0.5 to 15 atomic % based on the content of iron.

19. The magnetic tape in which the content of aluminum in each of the substantially granular magnetic particles contained in the uppermost magnetic layer is 0.5 to 15 atomic % based on the content of iron.

20. The magnetic tape in which the content of silicon in each of the substantially granular magnetic particles contained in the uppermost magnetic layer is 0.5 to 15 atomic % based on the content of iron.

21. The magnetic tape in which the content of nitrogen in each of the substantially granular iron nitride-based magnetic particles contained in the uppermost magnetic layer is 1.0 to 20 atomic % based on the content of iron.

22. The magnetic tape in which the content of nitrogen in each of the substantially granular iron nitride-based magnetic particles contained in the uppermost magnetic layer is 2.0 to 12.5 atomic % based on the content of iron.

23. The magnetic tape in which the rare earth element in each of the substantially granular rare earth-iron nitride-based magnetic particles contained in the uppermost magnetic layer is at least one selected from the group consisting or samarium, neodymium and yttorium.

24. A magnetic tape cartridge comprising a box-shaped casing, and a reel which has the magnetic tape wound thereon and which is assembled in the casing, wherein signals magnetically recorded on the magnetic tape are reproduced by a magnetoresistance magnetic head (MR head).

25. A magnetic tape cartridge comprising a box-shaped casing, and one reel which has the magnetic tape wound thereon and which is assembled in the casing, wherein the magnetic tape is tracked according to servo signals recorded on the magnetic tape.

26. The magnetic tape cartridge in which the servo signals are recorded on at least one of the magnetic layer and the backcoat layer of the magnetic tape.

27. The magnetic tape cartridge in which the servo signal is at least one servo signal selected from the group consisting of a magnetic servo signal and an optical servo signal.

28. The magnetic tape cartridge in which the servo signal is a magnetic servo signal which is reproduced by a magnetoresistance magnetic head (MR head).

### EXAMPLES

Hereinafter, the present invention will be described in more detail by the following Examples, which, however, should not be construed as limiting the scope of the present invention in any way. Throughout Examples, the term “parts” means “parts by weight”, unless otherwise specified.

### Example 1

<Components of Coating Composition for Primer Layer>
(1)

| | | |
|---|---|---|
| Needle-shaped iron oxide particles | 68 | parts |
| (average particle size = 100 nm, | | |
| axial ratio = 5) | | |
| Granular alumina particles | 8 | parts |
| (average particle size = 80 nm) | | |
| Carbon black | 24 | parts |
| (average particle size = 25 nm) | | |
| Stearic acid | 2.0 | parts |
| Vinyl chloride-hydroxypropyl acrylate copolymer | 8.8 | parts |
| (the content of —SO₃Na group = 0.7 × 10⁻⁴ eq./g) | | |
| Polyester-polyurethane resin | 4.4 | parts |
| (Tg = 40° C., and the content of —SO₃Na group = | | |
| 1 × 10⁻⁴ eq./g) | | |
| Cyclohexanone | 25 | parts |
| Methyl ethyl ketone | 40 | parts |
| Toluene | 10 | parts |

(2)

| | | |
|---|---|---|
| Butyl stearate | 1 | part |
| Cyclohexanone | 70 | parts |
| Methyl ethyl ketone | 50 | parts |
| Toluene | 20 | parts |

(3)

| | | |
|---|---|---|
| Polyisocyanate | 1.4 | parts |
| Cyclohexanone | 10 | parts |
| Methyl ethyl ketone | 15 | parts |
| Toluene | 10 | parts |

<Components of Magnetic Coating Composition>
(1) Components for use in the kneading step

| | | |
|---|---|---|
| Granular magnetic particles (Y—N—Fe) | 100 | parts |
| (powder A) | | |
| (each magnetic particle having an outer layer | | |
| portion mainly containing Y/Al, and | | |
| a core portion mainly containing a Fe₁₆N₂ phase; | | |
| Y/Fe = 5.5 atomic %, Al/Fe = 8.2 atomic %, and | | |
| N/Fe = 11.9 atomic %; Fe₁₆N₂ phase = a main phase; | | |
| saturation magnetization = 101.5 Am²/kg (101.5 emu/g); | | |
| Hc = 211.0 kA/m (2,650 Oe); average axial length = | | |
| 17 nm; and axial ratio = 1.2) | | |
| Vinyl chloride-hydroxypropyl acrylate copolymer | 13 | parts |
| (content of —SO₃Na group = 0.7 × 10⁻⁴ eq./g) | | |
| Polyester-polyurethane resin (PU) | 4.5 | parts |
| (content of —SO₃Na group = 1.0 × 10⁻⁴ eq./g) | | |
| Methyl acid phosphate (MAP) | 2 | parts |
| Tetrahydrofuran (THF) | 20 | parts |
| Methy ethyl ketone/cyclohexanone (MEK/A) | 9 | parts |

(2) Components for use in the diluting step

| | | |
|---|---|---|
| Palmitic acid amide (PA) | 1.5 | parts |
| n-Butyl stearate (SB) | 1 | part |
| Methy ethyl ketone/cyclohexanone (MEK/A) | 350 | parts |

(3) Components of Slurry

| | | |
|---|---|---|
| Granular alumina particles | 10 | parts |
| (average particle size = 80 nm) | | |
| Vinyl chlorid-hydroxypropyl acrylate copolymer | 1 | part |
| Methy ethyl ketone/cyclohexanone (MEK/A) | 15 | parts |

(4) Components for use in the blending step

| | | |
|---|---|---|
| Polyisocyanate | 1.5 | parts |
| Methyl ethyl ketone/cyclohexanone (MEK/A) | 29 | parts |

The components of the group (1) of a coating composition for primer layer were kneaded with a batch kneader, and the components of the group (2) were added. The mixture was stirred and then dispersed with a sand mill for a residence time of 60 minutes. To the resulting dispersion were added the components of the group (3), and the mixture was stirred and filtered to obtain the coating composition for primer layer.

Separately, the whole amount of the magnetic particles out of the components of the group (1) for the kneading step for a magnetic coating composition, and the predetermined amounts of the resin and the solvent were beforehand stirred and mixed at a high speed, and the resulting powder mixture was adjusted to the composition ratio indicated in the group (1), and then kneaded with a continuous twin-screw kneader. To the resulting knead-mixture were added the components of the group (2) for the diluting step, and the mixture was diluted in at least two stages with the continuous twin-screw kneader. The diluted mixture was dispersed with a sand mill using zirconia beads with a diameter of 0.5 mm as dispersing media, for a residence time of 45 minutes. To the dispersion was added a dispersion of the slurry components (3) prepared with a sand mill for a residence time of 40 minutes. To the dispersion mixture were added the components of the group (4) for the blending step, and the mixture was stirred and filtered to obtain the magnetic coating composition.

The above coating composition for primer layer was applied on a non-magnetic substrate (a base film) consisting of an aromatic polyamide film with a thickness of 3.3 μm (Mictron manufactured by Toray Industries, Inc.; MD=11 GPa, and MD/TD=0.70) so that the resultant primer layer could have a thickness of 0.6 μm after being dried and calendered. The above magnetic coating composition was applied on this primer layer by a wet-on-wet method so that the resultant magnetic layer could have a thickness of 0.09 μn after oriented in a magnetic field, dried and calendered. The coated magnetic layer was oriented in a magnetic field and dried with a drier and by far infrared radiation to obtain a magnetic sheet.

The orientation in a magnetic field was carried out under the following conditions: one set of N—N opposing magnets with lengths of 50 cm (0.5 T) were disposed in front of the drier, and five solenoid electromagnets with lengths of 50 cm (0.1 T) were disposed at intervals of 20 cm within the drier. The position at which the dryness of the coating layer could be felt by one's finger (the position where the particles were completely fixed) was between the fourth solenoid electromagnet and the fifth solenoid electromagnet. The coating speed was 100 m/min. (This method of applying a magnetic field is referred to the orientation method (A)).

The N—N opposing magnets were 20 cm distance from the solenoid electromagnets. The pole of the solenoid electromagnet near to the opposing magnets was the south pole.

<Components of Coating Composition for Backcoat Layer>

| | |
|---|---|
| Carbon black (average particle size = 25 nm) | 80 parts |
| Carbon black (average particle size = 0.35 μm) | 10 parts |
| Granular iron oxide particles | 10 parts |
| (average particle size = 50 nm) | |
| Nitrocellulose | 45 parts |
| Polyurethane resin (containing SO₃Na group) | 30 parts |
| Cyclohexanone | 260 parts |
| Methyl ethyl ketone | 525 parts |

The above components of a coating composition for backcoat layer were dispersed with a sand mill for a residence time of 45 minutes, and polyisocyanate (15 parts) was added to prepare the coating composition for backcoat layer. The coating composition was filtered and then applied on the other surface of the above magnetic sheet which had no magnetic layer formed thereon, so that the backcoat layer could have a thickness of 0.5 μm after being dried and calendered. Then, the backcoat layer was dried.

The magnetic sheet thus obtained was planished with a seven-stage calender consisting of metal rolls, at a temperature of 100° C. and under a linear pressure of 200 kg/cm. The resultant magnetic sheet was wound onto a core and aged at 70° C. for 72 hours. Then, the magnetic sheet was cut into strips with widths of ½ inches. While this strip was being run at a rate of 200 m/min., the surface of the magnetic layer of the strip was polished with a lapping tape followed by a blade, and wiped, to provide a magnetic tape. As the lapping tape, K10000 was used; as the blade, a carbide blade was used; and Toraysee (trade name) manufactured by Toray Industries, Inc. was used to wipe the surface of the magnetic tape. This treatment was carried out under a running tension of 0.294 N. Magnetic servo signals were recorded on the magnetic tape thus obtained, with a servo writer to provide a computer magnetic tape. The product Br.δ of the residual magnetic flux density and the thickness of the magnetic layer was 0.030 μTm. Then, this magnetic tape was assembled in a cartridge, to provide a computer magnetic tape cartridge.

### Examples 2 and 3

A magnetic tape was made in the same manner as in Example 1, except that the particle size of the magnetic particles (Y—N—Fe) out of the components of the magnetic coating composition of Example 1 was changed to 13 nm (Example 2) or 28 nm (Example 3) (the axial ratio was 1.2 in both Examples).

### Example 4

A magnetic tape was made in the same manner as in Example 1, except that the strength of the solenoid electromagnets for use in the orientation in a magnetic field was changed to 0.3 T.

### Example 5

A computer magnetic tape was made in the same manner as in Example 1, except that the orientation in a magnetic field of Example 1 was changed as follows: N—N opposing magnets with lengths of 50 cm (0.5 T) were disposed in front of the drier; and one set of S—S opposing magnets with lengths of 50 cm (0.5 T) and one set of N—N opposing magnets with lengths of 50 cm (0.5 T) were disposed at intervals of 50 cm and at positions 75 cm before the position at which the dryness of the coating layer was felt by one's finger within the drier. The coating rate was 100 m/min. (This method of applying a magnetic field is referred to as the orientation method (B).)

### Example 6

A magnetic tape was made in the same manner as in Example 1, except that the granular alumina particles out of the components of the magnetic coating composition were not added.

### Example 7

A magnetic tape was made in the same manner as in Example 1, except that magnetic particles (Al—Y—Co—Fe), (σs=110 Am²/kg (110 emu/g), Hc=159.2 kA/m (2,000 Oe), average particle size=35 nm, and axial ratio=3.5) were used as the magnetic particles out of the components of the magnetic coating composition of Example 1.

### Example 8

A computer magnetic tape was made in the same manner as in Example 1, except that only one set of N—N opposing magnets with lengths of 50 cm (0.5 T) were disposed in front of the drier without other magnets and solenoids. (This method of applying a magnetic field is referred to as the orientation method (C).)

### Example 9

A computer magnetic tape was made in the same manner as in Example 1, except that granular alumina particles with an average particle size of 160 nm were used instead of the alumina particles out of the components of the magnetic coating composition of Example 1, and that the dispersing media of the sand mill were changed to titania beads (φ=1.5 mm).

### Example 10

A computer magnetic tape was made in the same manner as in Example 1, except that the granular magnetic particles (Y—N—Fe) of Example 1 were changed to iron nitride particles (powder B) (Y/Fe=0.4 atomic %, Al/Fe=1.5 atomic %, N/Fe=12.2 atomic %, Fe₁₆N₂ phase=a main phase, saturation magnetization=105.5 Am²/kg (105.5 emu/g), Hc=202.9 kA/m (2,550 Oe), average axial length=17 nm, and axial ratio=1.2).

### Example 11

A computer magnetic tape was made in the same manner as in Example 5, except that the alumina particles out of the components of the magnetic coating composition of Example 5 were changed to granular alumina particles with an average particle size of 160 nm, and that the dispersing media of the sand mill were changed to titania beads (φ=1.0 mm).

### Example 12

A magnetic tape was made in the same manner as in Example 7, except that the magnetic particles out of the components of the magnetic coating composition of Example 7 were changed to magnetic particles (Al—Y—Co—Fe) (σs=120 Am²/kg (120 emu/g), Hc=171.1 kA/m (2,150 Oe), average particle size=100 nm, and axial ratio=6.0).

### Example 13

A magnetic tape was made in the same manner as in Example 1, except that the magnetic particles (Y—N—Fe) of Example 1 were changed to magnetic particles (Y/Fe=5.5 atomic %, Al/Fe=8.2 atomic %, N/Fe=12.2 atomic %, Fe₁₆N₂ phase=a main phase, saturation magnetization=105.5 Am²/kg (105.5 emu/g), Hc=211.0 kA/m (2,650 Oe), average axial length=35 nm, and axial ratio=1.2).

The evaluation of the computer magnetic tapes were made as follows.

<Particle Size of Magnetic Particles>

The magnetic tape as a sample, embedded in a resin, was cut in the thickness direction with a focused ion beam processing equipment so as to observe the section of the magnetic layer. The section of the magnetic layer was photographed using a scanning electron microscope (SEM) at a magnification of 200,000 times, to obtain a required number of photographs of the section thereof. The outer contours of the magnetic particles in the magnetic layer on the photograph were traced. The maximum diameter among the outer diameters of one particle was measured as the particle size. The particles sizes of fifty magnetic particles were measured in the same manner, and an average thereof was determined as an average particle size.

<Thickness of Magnetic Layer and Primer Layer>

The magnetic tape as a sample, embedded in a resin, was cut in the thickness direction on focused ion beam processing equipment. The section of the magnetic tape was photographed using a scanning electron microscope (SEM) at a magnification of 20,000 times to obtain the photographs of the section of the magnetic tape seen within ten fields of view. The outer contours of (1) the surface of the magnetic layer, (2) the interface between the magnetic layer and the primer layer, and (3) the interface between the primer layer and the non-magnetic substrate were traced. Next, five portions of the interface at which the non-magnetic particles were not observed were optionally selected per one field of view, and the distance between the tracing lines of the surface of the magnetic layer (1) and the interface (2) was measured as the thickness of the magnetic layer, and the distance between the tracing lines of the interface (2) and the interface (3) was measured as the thickness of the primer layer. The thickness of the magnetic layer and that of the primer layer were measured in the same manner with respect to ten fields of view, and the resultant values were averaged to determine the thickness of the magnetic layer and that of the primer layer.

<Output and Ratio of Output to Noise>

The electromagnetic converting performance of the magnetic tape was measured with a drum tester. The drum tester was equipped with an electromagnetic induction type magnetic head (track width=25 μm and a gap=0.1 μm) and a MR magnetic head (track width=8 μm), so as to record data with the induction type head and reproduce the recorded data with the MR head. Both the heads were set at different positions with respect to the rotary drum, and both the heads were moved up and down to match them with tracking of a magnetic tape. Some length of the magnetic tape was drawn out of the wound magnetic tape in the cartridge and scrapped, and a further 60 cm length of the magnetic tape was drawn and cut. The magnetic tape cut was shaped having a width of 4 mm, and was wound around the rotary drum.

The output and noises were determined as follows. Signals with a rectangular waveform having a wavelength of 0.2 μm were written on the magnetic tape with a function generator, and outputs from the MR magnetic head were read with a spectrum analyzer. The carrier value of 0.2 μm was determined as the reproducing output C from the medium. On the other hand, the noise value N was determined as follows. Signals with a rectangular waveform having a wavelength of 0.2 μm were written on the magnetic tape, and from the spectral component equivalent to not shorter than the recording wavelength of 0.2 μm, the reproducing output and the system noise were subtracted, and the resulting difference was integrated. This integrated value was used as the noise value N. The ratio of the carrier value to the integrated value was expressed as C/N. The values of C and C/N were expressed as relative values to the values (0.0) obtained from the magnetic tape of Example 5 as a reference.

The properties of the magnetic tapes prepared in the foregoing Examples and the conditions employed in the Examples are summarized in Table 1.

TABLE 1

| | Upper Magnetic | | | | | Beads in | |
|---|---|---|---|---|---|---|---|
| | Layer | | | | | Disperser | |
| | | Particle | | Composition of | | | Particle |
| | Magnetic | size | Axial | Magnetic | Method for | | size |
| | Powder | (nm) | Ratio | Powder | orientation | Material | (mm) |
| Ex. 1 | Iron | 17 | 1.2 | Powder A | A(SC) | Zirconia | 0.5 |
| | nitride | | | | | | |
| Ex. 2 | Iron | 13 | 1.2 | Powder A | A(SC) | Zirconia | 0.5 |
| | nitride | | | | | | |
| Ex. 3 | Iron | 28 | 1.2 | Powder A | A(SC) | Zirconia | 0.5 |
| | nitride | | | | | | |
| Ex. 4 | Iron | 17 | 1.2 | Powder A | A(SC) | Zirconia | 0.5 |
| | nitride | | | | | | |
| Ex. 5 | Iron | 17 | 1.2 | Powder A | B(Magnet) | Zirconia | 0.5 |
| | nitride | | | | | | |
| Ex. 6 | Iron | 17 | 1.2 | Powder A | A(SC) | Zirconia | 0.5 |
| | nitride | | | | | | |
| Ex. 7 | Iron | 35 | 3.5 | — | A(SC) | Zirconia | 0.5 |
| | alloy | | | | | | |
| Ex. 8 | Iron | 17 | 1.2 | Powder A | (C)Magnet | Zirconia | 0.5 |
| | nitride | | | | | | |
| Ex. 9 | Iron | 17 | 1.2 | Powder A | A(SC) | Titania | 1.5 |
| | nitride | | | | | | |
| Ex. 10 | Iron | 17 | 1.2 | Powder B | A(SC) | Zirconia | 0.5 |
| | nitride | | | | | | |
| Ex. 11 | Iron | 17 | 1.2 | Powder A | B(Magnet) | Titania | 1.0 |
| | nitride | | | | | | |
| Ex. 12 | Iron | 100 | 6.0 | — | A(SC) | Zirconia | 0.5 |
| | alloy | | | | | | |
| Ex. 13 | Iron | 35 | 1.2 | Powder A | A(SC) | Zirconia | 0.5 |
| | nitride | | | | | | |

| | | | | | | | Electro- | |
|---|---|---|---|---|---|---|---|---|
| | | | | | | | magnetic | |
| | Magnetic Properties | | | | | | Conversion | |
| | Squareness | | Hc_{M} | Hc_{T} | | Hc_{M} − Hc_{T} | C | C/N |
| | Ratio | SFD | (kA/m) | (kA/m) | Hc_{M}/Hc_{T} | (kA/m) | (dB) | (dB) |
| Ex. 1 | 0.82 | 0.61 | 250.2 | 89.0 | 2.81 | 161.2 | 2.4 | 3.1 |
| Ex. 2 | 0.80 | 0.64 | 245.3 | 90.1 | 2.72 | 155.2 | 1.6 | 2.8 |
| Ex. 3 | 0.83 | 0.63 | 257.7 | 101.9 | 2.53 | 155.8 | 2.5 | 1.5 |
| Ex. 4 | 0.83 | 0.59 | 268.5 | 81.1 | 3.31 | 187.4 | 2.7 | 3.4 |
| Ex. 5 | 0.77 | 0.65 | 235.2 | 106.4 | 2.21 | 128.8 | 0.0 | 0.0 |
| Ex. 6 | 0.82 | 0.60 | 251.5 | 90.8 | 2.77 | 160.7 | 2.3 | 3.1 |
| Ex. 7 | 0.86 | 0.65 | 190.5 | 121.4 | 1.57 | 69.1 | 0.5 | −3.1 |
| Ex. 8 | 0.70 | 0.70 | 220.7 | 131.5 | 1.68 | 89.2 | −1.5 | −2.1 |
| Ex. 9 | 0.77 | 0.67 | 226.4 | 132.0 | 1.72 | 94.4 | −1.4 | −1.8 |
| Ex. 10 | 0.82 | 0.66 | 249.4 | 135.5 | 1.84 | 113.9 | −1.0 | −0.8 |
| Ex. 11 | 0.70 | 0.67 | 220.2 | 133.4 | 1.65 | 86.8 | −2.1 | −2.0 |
| Ex. 12 | 0.87 | 0.49 | 202.5 | 132.7 | 1.53 | 69.8 | −1.2 | −7.5 |
| Ex. 13 | 0.84 | 0.60 | 250.0 | 113.0 | 2.21 | 137.0 | 3.0 | −3.7 |

Note:
SC = Solenoid electromagnet

As is apparent from Table 1, the computer magnetic tapes of Examples 1 to 6, each of which comprises the uppermost magnetic layer containing the substantially granular magnetic particles with a particle size of 30 nm or less, and showing 2.2 or more in the ratio of the coercive force in the machine direction to the coercive force in the transverse direction, i.e. [(the coercive force in the machine direction)/(the coercive force in the transverse direction)], are higher in the reproducing output (C) and the ratio of the reproducing output to the noises (C/N), than the computer magnetic tapes of Examples 8 to 12, each of which shows less than 2.2 in the ratio of the coercive force in the machine direction to the coercive force in the transverse direction. The computer magnetic tapes of Examples 1 to 6 are higher in electromagnetic converting performance, C and C/N, than the computer magnetic tape of Example 7 which comprises needle-shaped magnetic particles with an axial ratio of 3 or more. The computer magnetic tape of Example 13 which comprises magnetic particles with a particle size exceeding 30 nm is higher in reproducing output, but lower in C/N.

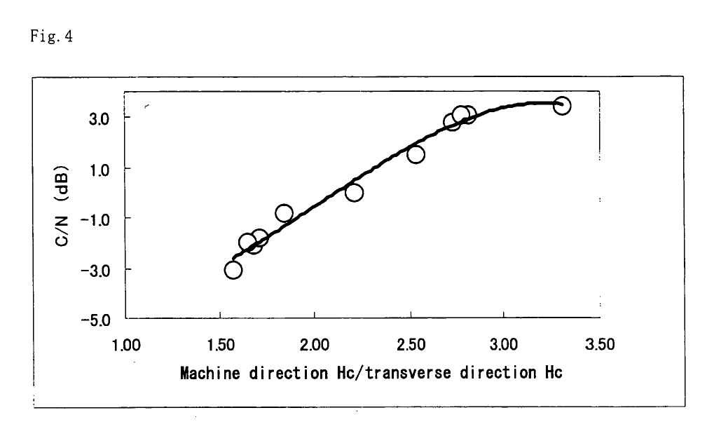

FIG. 4 shows a graph representing the relationship between the ratio of (the coercive force in the machine direction) to (the coercive force in the transverse direction) and the value of C/N. As is apparent from the graph of FIG. 4, the larger the value of Hc_{M}/Hc_{T}, the larger the value of C/N.

As is understood from the results of Examples, the magnetic tapes of the present invention are superior in electromagnetic converting performance (i.e. C and C/N).

1. A magnetic tape comprising a non-magnetic substrate and at least one magnetic layer formed on one surface of the non-magnetic substrate, wherein magnetic particles contained in an uppermost magnetic layer of said magnetic layer are substantially granular particles with a particle size of 30 nm or less, and the ratio of a coercive force Hc_{M} in the machine direction to a coercive force Hc_{T} in the transverse direction, [Hc_{M}/Hc_{T}], is at least 2.2.

2. The magnetic tape according to claim 1, wherein an axial ratio of the magnetic particles contained in said uppermost magnetic layer is less than 2.

3. The magnetic tape according to claim 1, wherein the magnetic particles contained in said uppermost magnetic layer are iron nitride-based magnetic particles.

4. The magnetic tape according to claim 1, wherein the particle size of the magnetic particles contained in said uppermost magnetic layer is 20 nm or less.
